(19) United States
(12) Patent Application Publication
(10) Pub. No.: US 2025/0309717 A1
(43) Pub. Date: Oct. 2, 2025

(54) MOTOR

(71) Applicant: NIDEC CORPORATION, Kyoto (JP)

(72) Inventors: Mitsuhiro TAKEMOTO, Kyoto (JP); Masahiro SHIRAISHI, Kyoto (JP)

(21) Appl. No.: 19/084,857

(22) Filed: Mar. 20, 2025

(30) Foreign Application Priority Data
Mar. 26, 2024 (JP) 2024-049564
Sep. 24, 2024 (JP) 2024-165177

(51) Int. Cl. H02K 3/24; H02K 1/18; H02K 7/00

(52) U.S. Cl. CPC H02K 3/24; H02K 1/187; H02K 7/003

(57) ABSTRACT

A motor includes a shaft, a stator, a rotor, a holding portion, and a heat dissipation portion. The shaft extends in a first direction along a central axis. The stator includes a coil and surrounds a radially outer periphery of the shaft. The rotor surrounds a radially outer periphery of the stator, and is rotatable with respect to the stator together with the shaft. The shaft is rotatably attached to the holding portion, and the holding portion holds the stator. The heat dissipation portion is in thermal contact with the coil. The holding portion further holds the heat dissipation portion.

### CROSS-REFERENCE TO RELATED APPLICATIONS

The present application claims priority under 35 U.S.C. § 119 to Japanese Patent Application No. 2024-049564, filed on Mar. 26, 2024, and Japanese Patent Application No. 2024-165177, filed on Sep. 24, 2024, the entire contents of each application are hereby incorporated herein by reference.

### 1. FIELD OF THE INVENTION

The present disclosure relates to motors.

### 2. BACKGROUND

A conventional motor includes a stator and a rotor rotatably disposed on a radially inner side of the stator. In a conventional motor, a stator includes a stator core having a cylindrical back yoke and teeth protruding radially inward from the back yoke, a coil wound around the teeth, an outer cylinder surrounding the back yoke, and a heat transfer portion abutting on both an inner peripheral surface of the outer cylinder and a coil end of the coil.

In addition to an inner rotor type motor in which a rotor is rotatably disposed on the radially inner side of the stator as in the conventional motor, there is also an outer rotor type motor in which a rotor is rotatably disposed on the radially outer side of the stator.

### SUMMARY

An example embodiment of a motor of the present disclosure includes a shaft, a stator, a rotor, a holding portion, and a heat dissipation portion. The shaft extends in a first direction along a central axis. The stator includes a coil and surrounds an outer periphery of the shaft in a radial direction. The rotor surrounds a radially outer periphery of the stator, and is rotatable with respect to the stator together with the shaft. The shaft is rotatably attached to the holding portion, and the holding portion holds the stator. The heat dissipation portion is in thermal contact with the coil. The holding portion further holds the heat dissipation portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a cross section along a rotation axis of a motor according to a first example embodiment of the present disclosure.

FIG. 2 is an enlarged view illustrating a region II in FIG. 1.

FIG. 3 illustrates a motor according to an example embodiment of the present disclosure viewed from the other side in the axial direction.

FIG. 4 illustrates a modification of a motor according to an example embodiment of the present disclosure as viewed from the other side in the axial direction.

FIG. 5 illustrates another modification of a motor according to an example embodiment of the present disclosure as viewed from the other side in the axial direction.

FIG. 6 is a diagram illustrating a cross section along a rotation axis of a motor 2 according to a second example embodiment of the present disclosure.

FIG. 7 illustrates a motor according to an example embodiment of the present disclosure viewed from one side in the axial direction.

FIG. 8 illustrates a motor according to an example embodiment of the present disclosure viewed from the other side in the axial direction.

### DETAILED DESCRIPTION

Hereinafter, a first example embodiment of the present disclosure will be described with reference to the drawings. In the drawings, the same or corresponding parts are denoted by the same reference numeral and description thereof will not be repeated. In the present specification, for easy understanding, a direction substantially parallel to a rotation axis of a motor is described as an axial direction Z, one side in the axial direction Z is described as one axial side Z1, and another side in the axial direction Z is described as the other axial side Z2. Further, a radial direction around the axial direction Z is described as a radial direction R, and a circumferential direction around the axial direction Z is described as a circumferential direction C. In the radial direction R, an axial direction Z side is described as an inner side in the radial direction R, and a side opposite to the axial direction Z side is described as an outer side in the radial direction R. However, the direction is defined merely for convenience of description, and the orientation at the time of use of a motor according to the present disclosure is not limited unless it is particularly necessary to define a horizontal direction and a vertical direction. In addition, an “orthogonal direction” in the present disclosure includes a substantially orthogonal direction.

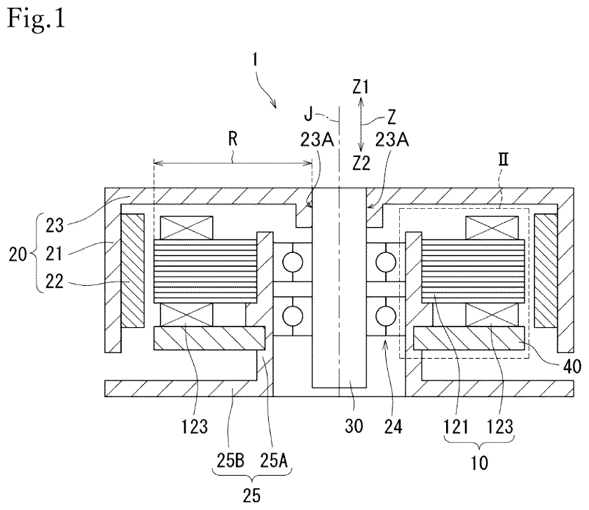

A first example embodiment of a motor 1 will be described with reference to FIG. 1. FIG. 1 is a diagram illustrating a cross section along a rotation axis of the motor 1 according to the first example embodiment.

As an example, the motor 1 is mounted on a drone. Typically, the motor 1 is used as a motor that rotates a propeller of a drone.

As illustrated in FIG. 1, the motor 1 includes a shaft 30 as a rotation axis, a stator 10, a rotor 20, a bearing 24, a bracket 25, and a heat dissipation portion 40. When the motor 1 is mounted on a drone, the shaft 30 extends in the axial direction Z along a central axis J. The shaft 30 is fixed to the rotor 20 and constitutes a rotation axis of the propeller. As an example, the propeller is attached to an end of the shaft 30 on the one axial side Z1. The stator 10 has an annular shape. The rotor 20 rotates relative to the stator 10. In the first example embodiment, the rotor 20 surrounds the outer periphery of the stator 10 in the radial direction R and covers the one axial side Z1 of the stator 10. The axial direction Z is an example of a first direction.

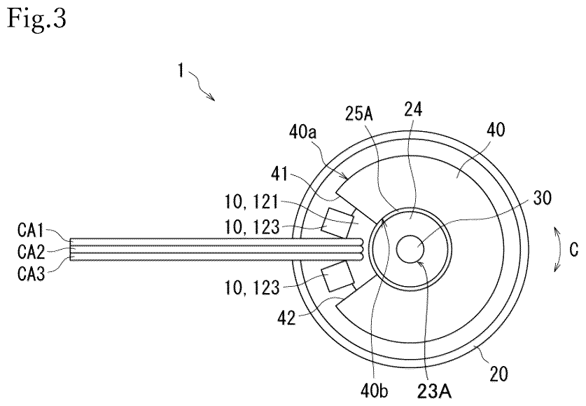

Specifically, the rotor 20 includes a yoke 21, a plurality of magnets 22, and an arm 23. Typically, the yoke 21 is a cylindrical, or annular, iron member surrounding the outer periphery of the stator 10. On an inner peripheral surface of the yoke 21, a plurality of the magnets 22 are arranged along the inner peripheral surface. Specifically, N poles and S poles of the plurality of the magnets 22 are alternately arranged in the circumferential direction C (FIG. 3 and elsewhere) on the inner peripheral surface of the yoke 21. The magnet 22 is composed of a permanent magnet in a rectangular parallelepiped shape, for example. In the first example embodiment, the plurality of magnets 22 are arranged side by side, but one annular magnet 22 in which N poles and S poles are alternately arranged may also be used.

The arm 23 connects the yoke 21 and the shaft 30. Typically, the rotor 20 is provided with two or more arms 23. The arms 23 each extend along the radial direction R of the rotor 20. In the first example embodiment, the arm 23 is provided on the one side Z1 in the axial direction with respect to the stator 10. For example, the arm 23 includes a connecting portion 23A that connects the end on the one axial side Z1 of the yoke 21 and the end on the one axial side Z1 of the shaft 30. The arm 23 covers the one axial side Z1 of the stator 10.

The stator 10 includes a stator core 121 and a coil 123. As illustrated in FIG. 1, the stator core 121 has an annular shape and is disposed inside the magnet 22 in the radial direction R with a gap interposed therebetween. Specifically, the stator core 121 is rotatably attached to the shaft 30 via the bracket 25 and the bearing 24. For example, the outer diameter of the stator core 121 is 35 mm to 40 mm.

The bracket 25 includes a cylindrical portion 25A having a cylindrical shape and located inside the stator core 121 in the radial direction R, and a cover portion 25B connected to the cylindrical portion 25A and covering the other axial side Z2 of the stator core 121.

The cylindrical portion 25A holds the stator 10. Specifically, the stator 10 is attached and fixed to the cylindrical portion 25A. In other words, the outer peripheral surface of the cylindrical portion 25A is in contact with the inner peripheral surface of the stator core 121. The bearing 24 is attached to the inner peripheral surface of the cylindrical portion 25A. That is, the center of the stator core 121 coincides with the center of the cylindrical portion 25A. As a result, the center of the stator core 121 substantially coincides with a central axis J of the shaft 30. The shaft 30 is rotatably attached to the cylindrical portion 25A via the bearing 24. Therefore, the rotor 20 rotates around the stator 10 together with the shaft 30 with the shaft 30 as an axis. The cylindrical portion 25A is an example of a holding portion. As described above, the motor 1 is an outer rotor type motor in which the rotor 20 located outside the stator 10 in the radial direction R rotates.

The stator core 121 is configured of a plurality of core members stacked in the axial direction Z. The core member is formed of, for example, an electromagnetic steel plate. The stator core 121 includes a core back (not illustrated) and a plurality of teeth (not illustrated).

The core back and the teeth are integrally formed. The core back surrounds the central axis J of the shaft 30 in the circumferential direction C, and is formed in an annular shape. Each of the teeth extends outward in the radial direction R from an outer surface in the radial direction R of the core back. The teeth are arranged at equal intervals along the circumferential direction C when viewed from the one axial side Z1. The inner peripheral surface of the core back in the radial direction R faces the outer peripheral surface of the cylindrical portion 25A in contact therewith.

The coil 123 is mounted on each of the teeth. Specifically, the coil 123 is formed by winding a conductive wire around each of the teeth. The conductive wire is a cable formed of a string-like conductor and an insulating film covering the periphery of the conductor. In the first example embodiment, a coil 123 corresponding to one of phases of three-phase alternating current is wound around each tooth.

The heat dissipation portion 40 is in thermal contact with the coil 123. Typically, the heat dissipation portion 40 is a plate-like member made of a high thermal conductive material such as metal, aluminum nitride, or fine ceramics containing silicon carbide. The heat dissipation portion 40 is held by the cylindrical portion 25A. In other words, the heat dissipation portion 40 is attached and fixed to the cylindrical portion 25A. The heat dissipation portion 40 is in contact with the coil 123 via a heat dissipation adhesive, a heat conductive sheet, or the like in a state of being attached to the cylindrical portion 25A. The heat dissipation portion 40 may be in direct contact with the coil 123 in a state of being attached to the cylindrical portion 25A.

As a result, the heat generated by the current flowing through the coil 123 is easily released into the air via the heat dissipation portion 40 and the cylindrical portion 25A. Since the heat dissipation portion 40 and the coil 123 are fixed to the cylindrical portion 25A, the positional relationship between the coil 123 and the heat dissipation portion 40 is less likely to change, and thermal conduction from the coil 123 to the heat dissipation portion 40 is stabilized. Therefore, in the outer rotor type motor, heat can be efficiently released from the coil 123.

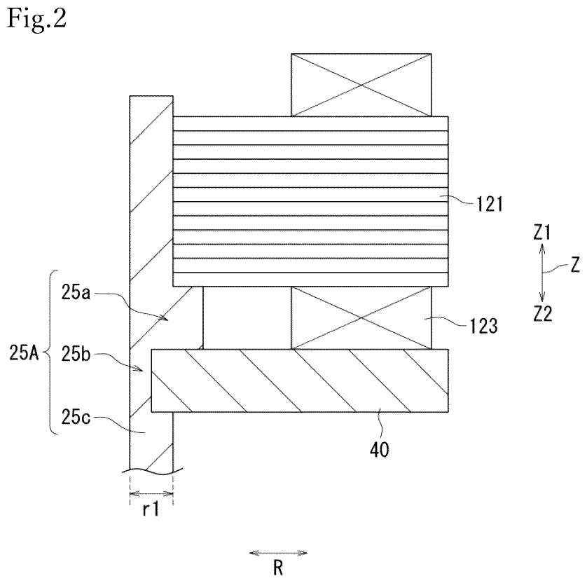

Next, attachment of the heat dissipation portion 40 will be described with reference to FIGS. 1 and 2. FIG. 2 is an enlarged view illustrating a region II in FIG. 1.

As illustrated in FIG. 1, the heat dissipation portion 40 is provided on the other axial side Z2 with respect to the stator 10. In other words, the heat dissipation portion 40 is disposed on the side opposite to the side where the arm 23 is located with respect to the stator 10 in the axial direction Z. As described above, in the motor 1, the heat dissipation portion 40 is provided on the open side where the arm 23 is not provided, so that the heat dissipation can be more easily improved.

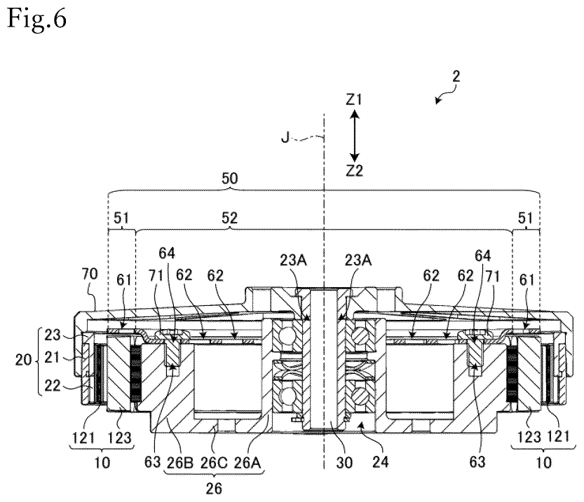

Note that the heat dissipation portion 40 may be disposed on the same side as the side where the arm 23 is located with respect to the stator 10 in the axial direction Z. That is, the heat dissipation portion 40 may be disposed on at least one of the one axial side Z1 and the other axial side Z2 with respect to the stator 10. A configuration example in which the heat dissipation portion is disposed on the one axial side Z1 with respect to the stator 10 will be described later as a second example embodiment with reference to FIGS. 6 to 8.

As illustrated in FIG. 2, the cylindrical portion 25A includes a cylindrical main body 25c extending in the axial direction Z and having a thickness r1 in the radial direction R, a protrusion 25a protruding outward in the radial direction R from the outer peripheral surface of the main body 25c, and a recess 25b recessed inward in the radial direction R from the outer peripheral surface of the main body 25c. That is, the thickness of the protrusion 25a in the radial direction R is larger than the thickness r1. The thickness of the recess 25b in the radial direction R is smaller than the thickness r1. The protrusion 25a and the recess 25b extend along the circumferential direction C. In the first example embodiment, the protrusion 25a is provided on the one axial side Z1 with respect to the recess 25b.

A part of the heat dissipation portion 40 including the inner peripheral surface is located in the recess 25b. The outer peripheral surface of the recess 25b faces the inner peripheral surface of the heat dissipation portion 40. As a result, the heat dissipation portion 40 is less likely to move from the recess 25b. As a result, the position of the heat dissipation portion 40 with respect to the coil 123 is easily stabilized.

In addition, the protrusion 25a provided on the one axial side Z1 with respect to the recess 25b makes it more difficult for the heat dissipation portion 40 to move from the recess 25b toward the one axial side Z1.

On the other hand, the stator 10 is disposed on the one axial side Z1 with respect to the protrusion 25a. As a result, the stator 10 is less likely to move toward the other axial side Z2 with respect to the protrusion 25a.

As described above, the stator 10 and the heat dissipation portion 40 are less likely to move in the direction approaching each other in the axial direction Z by the protrusion 25a. As a result, the positional relationship between the coil 123 and the heat dissipation portion 40 is easily fixed.

Note that the cylindrical portion 25A may have only one of the protrusion 25a and the recess 25b.

As illustrated in FIG. 1 and described above, the cover portion 25B is formed as a part of the bracket 25. That is, the cover portion 25B is fixed to the cylindrical portion 25A. Therefore, the heat of the coil 123 is transferred to the cover portion 25B via the heat dissipation portion 40 and the cylindrical portion 25A. Therefore, by providing the cover portion 25B, the contact area of the motor 1 with the air can be increased, and the heat dissipation efficiency is easily improved.

In the first example embodiment, the cover portion 25B and the heat dissipation portion 40 are located apart from each other in the axial direction Z. As a result, a contact area with the air becomes larger than the case where the cover portion 25B and the heat dissipation portion 40 are disposed close to each other in the axial direction Z. Therefore, the heat dissipation efficiency is more easily improved. Note that the heat dissipation portion 40 and the cover portion 25B may not be separated from each other in the axial direction Z.

Next, the heat dissipation portion 40 will be described with reference to FIG. 3. FIG. 3 illustrates a motor 1 as viewed from the other axial side Z2. In FIG. 3, the cover portion 25B is omitted for easy understanding of the drawing.

As illustrated in FIG. 3, the heat dissipation portion 40 has a shape extending in an arc shape along the stator 10. In this manner, by forming the shape of the heat dissipation portion 40 in a shape conforming to the shape of the stator 10, the contact area of the heat dissipation portion 40 with respect to the stator 10 can be increased. Typically, the heat dissipation portion 40 has a C-shape. Specifically, the heat dissipation portion 40 is one annular plate, and has a shape in which a part in the circumferential direction C is missing from the outer periphery 40a to the inner periphery 40b in the radial direction R.

In the first example embodiment, the motor 1 includes cables CA1, CA2, and CA3 extending from the stator 10 toward the outside of the stator 10 in the radial direction R. The cables CA1, CA2, and CA3 are conductive wires electrically connected to the coil 123, and various forms such as a lead wire, a metal bus bar, a terminal, and a conductive wire in which the lead wire, the metal bus bar, and the terminal are combined can be considered. The description of the connection between the conductive wire forming the coil 123 and the cables CA1, CA2, and CA3 is omitted. The cables CA1, CA2, and CA3 are drawn out from any of the plurality of coils 123 arranged in the stator 10 toward the outside of the stator 10 in the radial direction R.

The heat dissipation portion 40 is disposed so as to avoid the cables CA1, CA2, and CA3 in the circumferential direction C of the stator 10. In this manner, the motor 1 can be formed compactly in the axial direction Z by securing the wiring regions of the cables CA1, CA2, and CA3.

Specifically, the heat dissipation portion 40 has a first end 41 and a second end 42 opposite to the first end 41. The first end 41 and the second end 42 connect the outer periphery 40a and the inner periphery 40b of the heat dissipation portion 40, respectively. The cables CA1, CA2, and CA3 are located in a region of the stator 10 between the first end 41 and the second end 42 and not covered by the heat dissipation portion 40. As described above, in the motor 1, the heat dissipation portion 40 is disposed while avoiding the cables CA1, CA2, and CA3, and a compact structure can be easily formed in the axial direction Z.

For example, the heat dissipation portion 40 has a length equal to or longer than a half circumference of the stator 10 along the circumferential direction C. As a result, more than half of the plurality of coils 123 arranged in the stator 10 can be covered with the heat dissipation portion 40. As a result, heat dissipation efficiency can be improved with respect to more coils 123 by the heat dissipation portion 40.

Note that the heat dissipation portion 40 may be formed by connecting and arranging a plurality of plates in a C shape other than forming one plate in a C shape.

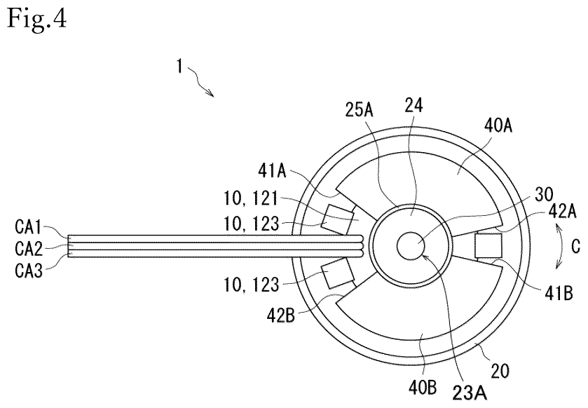

Next, a modification of the arrangement of the heat dissipation portion 40 will be described with reference to FIG. 4. FIG. 4 illustrates a modification of the motor 1 as viewed from the other axial side Z2. In FIG. 4, similarly to FIG. 3, the cover portion 25B is omitted.

The modification of the motor 1 includes a heat dissipation portion 40A and a heat dissipation portion 40B instead of the heat dissipation portion 40. The heat dissipation portion 40A and the heat dissipation portion 40B each have a shape extending in an arc shape along the stator 10. The heat dissipation portion 40A and the heat dissipation portion 40B are arranged side by side along the circumferential direction C. The heat dissipation portion 40A has a first end 41A and a second end 42A. The heat dissipation portion 40B has a first end 41B and a second end 42B. The cables CA1, CA2, and CA3 are disposed between the first end 41A of the heat dissipation portion 40A and the second end 42B of the heat dissipation portion 40B. The cables CA1, CA2, and CA3 may be disposed between the first end 41B of the heat dissipation portion 40B and the second end 42A of the heat dissipation portion 40A.

In the modification of the motor 1, more heat dissipation portions may be disposed in addition to the heat dissipation portion 40A and the heat dissipation portion 40B.

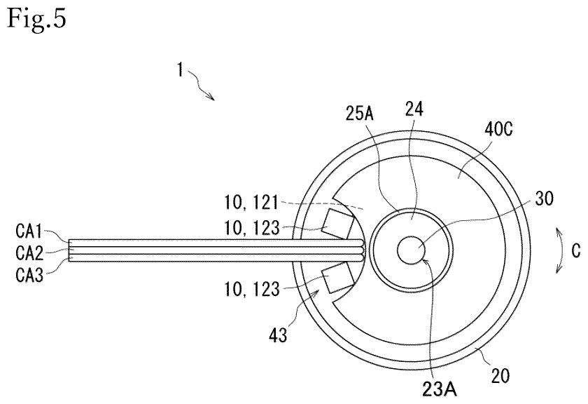

Next, a modification of the shape of the heat dissipation portion 40 will be described with reference to FIG. 5. FIG. 5 illustrates another modification of the motor 1 as viewed from the other axial side Z2. In FIG. 5, similarly to FIG. 3, the cover portion 25B is omitted.

Another modification of the motor 1 includes a heat dissipation portion 40C instead of the heat dissipation portion 40. The heat dissipation portion 40C has an annular shape. In addition, the heat dissipation portion 40C has a cutout portion 43 in which a part of the outer periphery is cut out along the circumferential direction C. The inner periphery of the heat dissipation portion 40C surrounds the entire outer periphery of the cylindrical portion 25A. The cables CA1, CA2, and CA3 are disposed in the cutout portion 43 of the heat dissipation portion 40C.

In the first example embodiment, the heat dissipation portion 40 and the cover portion 25B may have functions of each other. For example, the heat dissipation portion 40 and the cover portion 25B may be integrally formed of a single member. Further, the cylindrical portion 25A and the cover portion 25B are integrally formed as a single member as the bracket 25, but the cylindrical portion 25A and the cover portion 25B may be separate members.

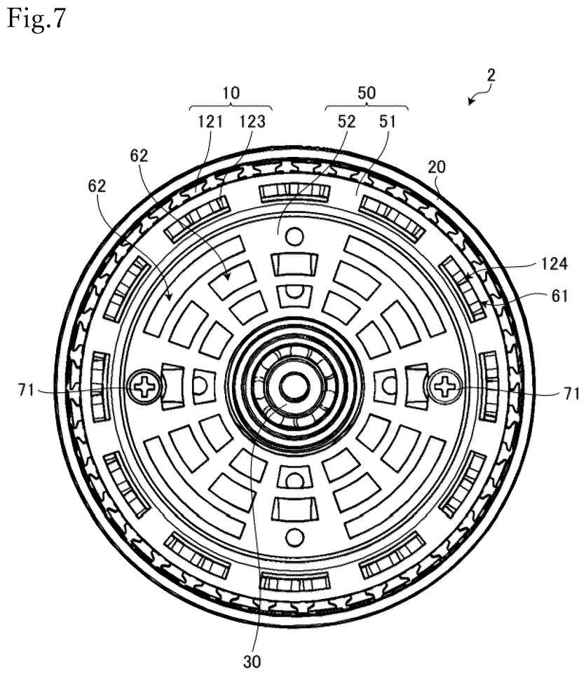

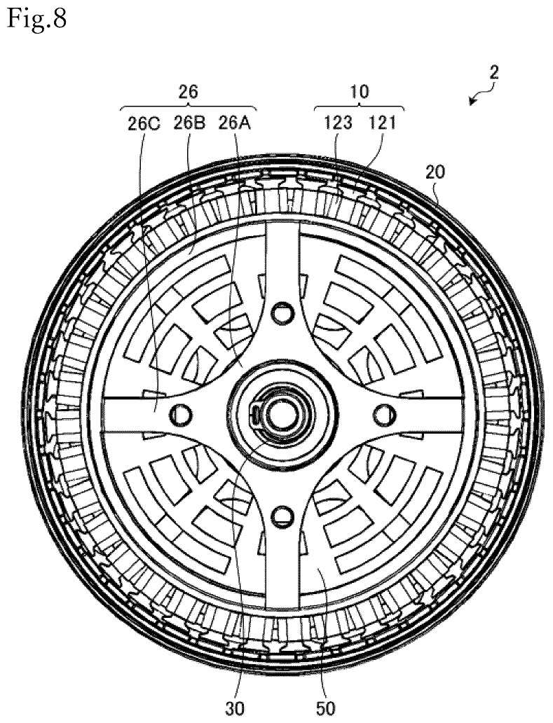

Next, a motor 2 according to a second example embodiment will be described with reference to FIGS. 6 to 8. FIG. 6 is a diagram illustrating a cross section along a rotation axis of the motor 2 according to the second exemplary example embodiment. FIG. 7 is a diagram illustrating the motor 2 as viewed from the one axial side Z1. In FIG. 7, the cover portion 70 is omitted for easy understanding of a heat dissipation portion 50. FIG. 8 illustrates the motor 2 as viewed from the other axial side Z2.

In the motor 2, a propeller of a drone is attached to an end on one axial side Z1 of the shaft 30. The motor 2 rotates the propeller to rotate the shaft 30 in a rotation direction in which the air is blown from the one axial side Z1 toward the other axial side Z2.

The motor 2 includes a cover portion 70 that covers a part from the end surface on the one axial side Z1 of the rotor 20 to the side circumferential surface of the rotor 20. The motor 2 of the second example embodiment is different from the motor 1 of the first example embodiment in the position where the heat dissipation portion 50 is provided.

As an example, the rotor 20 of the motor 2 has a connecting portion 23A connected to the shaft 30 as in the first example embodiment. The connecting portion 23A is provided on the one axial side Z1 with respect to the stator 10. The heat dissipation portion 50 is provided on the one axial side Z1 with respect to the stator 10.

As a result, since the distance between the propeller and the heat dissipation portion 50 is shorter in the motor 2 than in the motor 1 of the first example embodiment, the wind generated by the rotation of the propeller can be efficiently applied to the heat dissipation portion 50, so that the heat dissipation efficiency is easily improved.

The heat dissipation portion 50 of the motor 2 is fixed to the holding portion 26. As an example, as illustrated in FIGS. 6 and 8, the holding portion 26 includes a first tubular portion 26A, a second tubular portion 26B, and a coupling portion 26C. The first tubular portion 26A surrounds the shaft 30. The shaft 30 is rotatably inserted into the first tubular portion 26A.

The second tubular portion 26B surrounds the first tubular portion 26A and holds the stator 10. The coupling portion 26C is formed in an elongated flat plate shape radially connecting an end portion on the one axial side Z1 of the first tubular portion 26A and an end portion on the one axial side Z1 of the second tubular portion 26B. The holding portion 26 includes a plurality of coupling portions 26C. In the example illustrated in FIG. 8, the holding portion 26 includes four coupling portions 26C.

On the other hand, as illustrated in FIGS. 6 and 7, the heat dissipation portion 50 of the motor 2 includes an annular portion 51 formed in an annular shape and a disk portion 52 formed in a disk shape. The annular portion 51 and the disk portion 52 are integrally formed. The annular portion 51 covers the end surface on the one axial side Z1 of the annular stator 10 surrounding the shaft 30. The disk portion 52 covers a central cavity of the annular stator 10.

In the heat dissipation portion 50, the height position of the disk portion 52 is lower than the height position of the annular portion 51. That is, the disk portion 52 is located on the other axial side Z2 with respect to the annular portion 51. In the heat dissipation portion 50, the disk portion 52 is fixed to the holding portion 26 with a screw 71.

Specifically, the second tubular portion 26B of the holding portion 26 includes a screw hole 63 extending from the end on the one axial side Z1 toward the other axial side Z2. On the other hand, the heat dissipation portion 50 includes a screw hole 64 at a position corresponding to the screw hole 63. The heat dissipation portion 50 is fixed to the holding portion 26 by screwing the screw 71 from the one axial side Z1 toward the other axial side Z2 into the aligned screw holes 63 and 64.

At this time, since the disk portion 52 is located on the other axial side Z2 with respect to the annular portion 51, the screw head of the screw 71 is less likely to protrude to the one axial side Z1 with respect to the annular portion 51. As a result, in the motor 2, the thickness of the member including the stator 10 and the heat dissipation portion 50 in the axial direction Z can be suppressed from increasing, so that the thickness can be reduced.

The annular portion 51 of the heat dissipation portion 50 is provided with a plurality of first vent holes 61 penetrating the annular portion 51 in the axial direction Z. Therefore, the heat dissipation portion 50 can directly apply the wind sent from the propeller to the stator 10. As a result, the stator 10 is easily cooled by the air cooling effect.

The first vent hole 61 is provided at least at a position facing a space 124 between the plurality of coils 123 provided along the circumferential direction of the stator 10. Therefore, the motor 2 can cause the wind sent from the propeller to pass from the one axial side Z1 to the other axial side Z2 through the space 124 between the adjacent coils 123 from the first vent hole 61. As a result, the motor 2 can efficiently release the heat generated by the coil 123 to the outside of the motor 2.

The disk portion 52 of the heat dissipation portion 50 is provided with a plurality of second vent holes 62 penetrating the disk portion 52 in the axial direction Z. Therefore, the motor 2 can cause the wind generated by the rotation of the propeller to pass from the one axial side Z1 to the other axial side Z2 through the second vent holes 62. Moreover, in the holding portion 26, a region surrounded by the first tubular portion 26A, the second tubular portion 26B, and the coupling portion 26C is hollow.

Therefore, the motor 2 can efficiently release the heat, transmitted from the annular portion 51 of the heat dissipation portion 50 to the disk portion 52, to the outside of the motor 2 through the second vent holes 62 and the cavity formed in the holding portion 26 by carrying the heat on the wind sent from the propeller.

In addition, the radially outer end of the heat dissipation portion 50 is located radially inside the radially outer end of the stator 10. That is, the diameter of the heat dissipation portion 50 around the central axis J is smaller than the diameter of the stator 10 around the central axis J.

Therefore, the heat dissipation portion 50 does not protrude outward in the radial direction of the stator 10 from the stator 10. As a result, the heat dissipation portion 50 does not come into contact with the rotor 20 even when the rotor 20 rotates with respect to the stator 10.

In addition, an adhesive having heat dissipation and elasticity is provided between the end surface on the one axial side Z1 of the plurality of coils 123 provided along the circumferential direction of the stator 10 and the heat dissipation portion 50. That is, the heat dissipation portion 50 and the coil 123 are bonded by an adhesive having heat dissipation and elasticity.

As a result, the motor 2 can efficiently transfer the heat generated by the coil 123 to the heat dissipation portion 50 via the adhesive. Further, in the motor 2, since the adhesive has elasticity, even when the stator 10 vibrates, it is possible to suppress separation of the coil 123 and the heat dissipation portion 50. Therefore, even when the stator 10 vibrates, the motor 2 can continuously transmit the heat generated by the coil 123 to the heat dissipation portion 50.

The example embodiments of the present disclosure are described above with reference to the drawings. However, the present disclosure is not limited to the above example embodiments, and can be implemented in various modes without departing from the gist of the present disclosure. Further, a plurality of constituent elements disclosed in the above example embodiments can be appropriately modified. For example, a certain constituent element of all constituent elements illustrated in a certain example embodiment may be added to constituent elements of another example embodiment, or some constituent elements of all constituent elements illustrated in a certain example embodiment may be removed from the example embodiment.

For example, the motor 1 of the first example embodiment may further include the heat dissipation portion 50 of the second example embodiment. The motor 2 of the second example embodiment may further include the heat dissipation portion 40 of the first example embodiment.

As a result, in the motor 1 according to the first example embodiment and the motor 2 according to the second example embodiment, the rotor 20 is cooled by both the heat dissipation portion 40 provided on the one axial side Z1 of the rotor 20 and the heat dissipation portion 50 provided on the other axial side Z2. Accordingly, the cooling performance of the motor 1 according to the first example embodiment and the motor 2 according to the second example embodiment is further improved.

The heat dissipation portion 50 of the second example embodiment is not limited to the members illustrated in FIGS. 6 to 8 as long as it is a member having a heat dissipation function and a ventilation function. In one example, the heat dissipation portion 50 may be a mesh member made of a high thermal conductive material such as metal, aluminum nitride, or fine ceramics containing silicon carbide.

Further, the drawings schematically illustrate each constituent element mainly in order to facilitate understanding of the disclosure, and the thickness, length, number, interval, and the like of the illustrated constituent elements may be different from the actual ones for convenience of creation of the drawings. The configuration of each component shown in the above example embodiments is an example and is not particularly limited, and it goes without saying that various modifications can be made without substantially departing from the effects of the present disclosure.

The example embodiments and techniques of the present disclosure can have configurations below.
(1) A motor including a shaft extending in a first direction along a central axis, a stator including a coil and surrounding an outer periphery of the shaft in a radial direction, a rotor that surrounds a radially outer periphery of the stator and is rotatable with respect to the stator together with the shaft, a holding portion to which the shaft is rotatably attached and which holds the stator, and a heat dissipation portion that is in thermal contact with the coil, wherein the holding portion further holds the heat dissipation portion.
(2) The motor according to (1), wherein the rotor includes a connecting portion connected to the shaft, the connecting portion is provided on one side in the first direction with respect to the stator, and the heat dissipation portion is provided on the one side in the first direction with respect to the stator.
(3) The motor according to (2), wherein the heat dissipation portion includes an annular portion surrounding the shaft and has an annular shape covering an end surface on the one side in the first direction of the stator in an annular shape, and the annular portion is provided with first vent holes penetrating a portion covering the stator in the first direction.
(4) The motor according to (3), wherein one of the first vent holes is provided at a position opposing at least a space between stator coils provided along the circumferential direction of the stator.
(5) The motor according to (4), wherein the heat dissipation portion includes a disk portion provided in a disk shape covering a central cavity of the stator in an annular shape, and the disk portion is provided with second vent holes penetrating the disk portion in the first direction.
(6) The motor according to (5), wherein in the heat dissipation portion, a height position of the disk portion is lower than a height position of the annular portion, and the disk portion is fixed to the holding portion with a screw.
(7) The motor according to any one of (2) to (6), wherein the holding portion includes a first tubular portion surrounding a periphery of the shaft, a second tubular portion surrounding a periphery of the first tubular portion and holding the stator, and elongated coupling portions radially connecting an end portion on another side in the first direction of the first tubular portion and an end portion on the other side in the first direction of the second tubular portion.
(8) The motor according to any one of (2) to (7), wherein a radially outer end of the heat dissipation portion is located on a radially inner side of an outer end of the stator in the radial direction.
(9) The motor according to any one of (2) to (8), wherein an adhesive including heat dissipation properties and elasticity is provided between an end surface on the one side in the first direction of the stator coils provided along a circumferential direction of the stator and the heat dissipation portion.
(10) The motor according to any one of (2) to (9), further including a heat dissipation portion provided on another side in the first direction with respect to the stator.
(11) The motor according to any one of (2) to (10), wherein a propeller of a drone is attached to the shaft on the one side in the first direction.
(12) The motor according to (1), wherein the rotor includes a connecting portion connected to the shaft, the connecting portion is provided on the one side in the first direction with respect to the stator, and the heat dissipation portion is provided on another side in the first direction with respect to the stator.
(13) The motor according to (12), further including a cover that is fixed to the holding portion and covers the other side in the first direction of the heat dissipation portion.
(14) The motor according to (13), wherein the cover and the heat dissipation portion are spaced apart from each other in the first direction.
(15) The motor according to any one of (12) to (14), wherein the heat dissipation portion has a an arc shape extending along the stator.
(16) The motor according to (15), further including a cable extending from the stator toward an outside in a radial direction of the stator, wherein the heat dissipation portion is located to avoid the cable in a circumferential direction of the stator.
(17) The motor according to (16), wherein the heat dissipation portion has a C-shape, and the cable is located between a first end of the heat dissipation portion and a second end opposite to the first end.

Example embodiments of the present disclosure are applicable to the field of motors.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a shaft extending in a first direction along a central axis;
a stator including a coil and surrounding an outer periphery of the shaft in a radial direction;
a rotor that surrounds a radially outer periphery of the stator and is rotatable with respect to the stator together with the shaft;
a holding portion to which the shaft is rotatably attached and which holds the stator; and
a heat dissipation portion that is in thermal contact with the coil; wherein
the holding portion further holds the heat dissipation portion.

2. The motor according to claim 1, wherein
the rotor includes a connecting portion connected to the shaft;
the connecting portion is provided on one side in the first direction with respect to the stator; and
the heat dissipation portion is provided on the one side in the first direction with respect to the stator.

3. The motor according to claim 2, wherein the heat dissipation portion includes an annular portion surrounding the shaft and provided in an annular shape covering an end surface on the one side in the first direction of the stator in an annular shape, and the annular portion is provided with first vent holes penetrating a portion covering the stator in the first direction.

4. The motor according to claim 3, wherein one of the first vent holes is provided at a position opposing at least a space between stator coils provided along a circumferential direction of the stator.

5. The motor according to claim 4, wherein the heat dissipation portion includes a disk portion with a disk shape covering a central cavity of the stator in an annular shape, and the disk portion is provided with second vent holes penetrating the disk portion in the first direction.

6. The motor according to claim 5, wherein in the heat dissipation portion, a height position of the disk portion is lower than a height position of the annular portion, and the disk portion is fixed to the holding portion with a screw.

7. The motor according to claim 2, wherein
the holding portion includes:
a first tubular portion surrounding a periphery of the shaft;
a second tubular portion surrounding a periphery of the first tubular portion and holding the stator; and
elongated coupling portions radially connecting an end portion on another side in the first direction of the first tubular portion and an end portion on the other side in the first direction of the second tubular portion.

8. The motor according to claim 2, wherein a radially outer end of the heat dissipation portion is located on a radially inner side of an outer end of the stator coil in the radial direction of the stator.

9. The motor according to claim 2, wherein an adhesive with heat dissipation properties and elasticity is provided between an end surface on the one side in the first direction of the stator coils provided along a circumferential direction of the stator and the heat dissipation portion.

10. The motor according to claim 2, further comprising a heat dissipation portion provided on another side in the first direction with respect to the stator.

11. The motor according to claim 2, wherein a propeller of a drone is attached to the shaft on the one side in the first direction.

12. The motor according to claim 1, wherein
the rotor includes a connecting portion connected to the shaft;
the connecting portion is provided on the one side in the first direction with respect to the stator; and
the heat dissipation portion is provided on another side in the first direction with respect to the stator.

13. The motor according to claim 12, further comprising a cover that is fixed to the holding portion and covers the other side in the first direction of the heat dissipation portion.

14. The motor according to claim 13, wherein the cover and the heat dissipation portion are spaced apart from each other in the first direction.

15. The motor according to claim 1, wherein the heat dissipation portion has an arc shape extending along the stator.

16. The motor according to claim 15, further comprising:
a cable extending from the stator toward an outside of the stator in a radial direction; wherein
the heat dissipation portion is positioned to avoid the cable in a circumferential direction of the stator.

17. The motor according to claim 16, wherein
the heat dissipation portion has a C-shape; and
the cable is located between a first end of the heat dissipation portion and a second end opposite to the first end.
